(19) United States
(12) Patent Application Publication
(10) Pub. No.: US 2010/0197888 A1
(43) Pub. Date: Aug. 5, 2010

(54) Method for Manufacturing Linear Polyethylenimine (PEI) for Transfection Purpose and Linear PEI Obtained with Such Method

(75) Inventors: Abdennaji Adib, Illkirch (FR); Fabrice Stock, Lingolsheim (FR); Patrick Erbacher, Illkirch Graffenstaden (FR)

Correspondence Address: BANNER & WITCOFF, LTD., 1100 13th STREET, N.W., SUITE 1200, WASHINGTON, DC, 20005-4051, US

(73) Assignee: Polyplus Transfection, Ilkirch Graffenstaden (FR)

(21) Appl. No.: 12/671,312

(22) PCT Filed: Jul. 31, 2008
(86) PCT No.: PCT/IB2008/002339

§ 371 Date: Apr. 8, 2010

Related U.S. Application Data
(60) Provisional application No. 60/952,993, filed on Jul. 31, 2007.

(51) Int. Cl. C08G 73/06

(52) U.S. Cl. 528/423

(57) ABSTRACT

The invention concerns a method of synthesising and preparing linear polyethylenimine (PEI) for use as a transfection vector, and the product obtained with such a method. It comprises drying a monomer 2-ethyl-2-oxazoline and polymerising said monomer for obtaining poly (2-ethyl-2-oxazoline) (PEOX) by: using acetonitrile as solvent, adding a dried initiator of the reaction of polymerisation, and mixing them altogether, purifying said obtained PEOX by evaporation, while performing at least three times successive washing/precipitation steps with methanol and diethyl ether and corresponding filtrations, in order to obtain (i), by performing 1H-NMR tests, correct identification of said PEOX polymer, confirmation of absence of monomer to a level <1.0% and confirmation of absence of solvent to a level <5.0% and (ii), by performing Gel Permeation Chromatography, a mean of molecular weight (Mw)>23,000 Da and polydispersity (Mw/Mn) of said PEOX<1.5, hydrolysing said PEOX.

The present invention concerns the manufacture and quality control of linear Polyethylenimine (PEI) for transfection applications.

The invention also relates to a product obtained with such manufacturing method, and more specifically for application in vivo including but not limitated to nuclear acid based therapy.

This application is a non provisional application concerning and claiming priority of earlier U.S. provisional application 60/952,993.

Polyethylenimine (PEI) is an organic macromolecule with a high cationic-charge-density potential. Every third atom of PEI is an amino nitrogen that can be protonated. PEI can ensnare DNA, and, owing to the close location of many linker amino groups, PEI retains a substantial buffering capacity at virtually any pH.

PEI alone is a highly efficient vector for delivering DNA plasmids both in vitro and in vivo.

PEI compacts DNA into positively charged particles capable of interacting with anionic proteoglycans at the cell surface and facilitating entry of the particles by endocytosis. Positively charged particles attach to anionic cell-surface proteoglycans at the cell surface and are subsequently spontaneously endocytosed (Boussif et. al., 1995). PEI also possesses the unique property of acting as a “proton sponge” and this buffers the endosomal pH and protects DNA from degradation, once it has entered the cell. Sustained proton influx also induces endosomal osmotic swelling and rupture which provides an escape mechanism for DNA particles to the cytoplasm (Boussif, et. al., 1995; Behr, 1997).

In summary, PEI-based delivery systems mimic some of the key properties of viruses, such as DNA condensation/protection and endosome escape.

Several manufacturing methods exist for PEI.

This is indeed due to the fact that such polymer has been used in a plurality of fields of the Industry since many years.

However, when used for transfection purpose, the efficiency of such PEI is often not good, i.e. less than 10% of the manufactured products succeed in transfer into a cell.

In particular there is low efficiency for high molecular weight of PEI, i.e. >10,000 Da.

Furthermore, and as soon as such product is to be used in the medical field and more particularly for genetic therapy with high standard of manufacturing such as the GMP standard, exceptional efficiency and quality are requested.

The present invention aims to solve this problem and allows great efficiencies 55%) with high molecular weight and a low polydispersity.

For this purpose, it is an object of the present invention to provide an improved method of synthesising and preparing a linear polyethylenimine (PEI) which renders possible an efficiency and reliability of the transfection better than the ones already known, with higher quality.

In one preferred embodiment, the quality is the standard one for GMP (Good Manufacturing Product).

More precisely, the invention proposes a method of synthesising and preparing linear polyethylenimine (PEI) for use as a transfection vector comprising the steps of, from a determined quantity of monomer 2-ethyl-2-oxazoline at a purity superior to 99%, thoroughly drying said quantity of monomer, and polymerising said quantity of monomer for obtaining poly(2-ethyl-2-oxazoline) (PEOX) by:

after thorough drying of a predetermined quantity of acetonitrile, using said acetonitrile as solvent in said quantity of dried monomer, while adding a predetermined quantity of thoroughly dried initiator of the reaction of polymerisation, and mixing them altogether,

purifying said obtained PEOX by evaporation to remove said solvent, while performing at least three times successive washing/precipitation steps with methanol and diethyl ether and corresponding filtrations,

said operations of drying, polymerising, and purifying being arranged to obtain (i), by performing ¹H NMR tests, correct identification of said PEOX polymer, confirmation of absence of monomer to a level <1.0% and confirmation of absence of solvent to a level <5.0% and (ii), by performing Gel Permeation Chromatography, a mean of molecular weight (Mw)>23,000 Da and polydispersity (Mw/Mn) of said PEOX<1.5,

hydrolysing said PEOX with hydrochloric acid for obtaining said PEI sufficiently efficiently to have, by performing ¹H-NMR tests, an amount of residual side chains or propionic acid <5% and to identify the PEI as a single peak.

By thoroughly drying a specific quantity of monomer, acetonitrile or the initiator, one should understand obtaining, just before use, a reduction of the humidity below 10 ppm of water, which can be obtained by drying on calcium hydride over 48 h and then by distillation and collecting the monomer above the temperature of 129° C.

The present invention also proposes advantageous embodiments including, but not limited to, one and/or a plurality of the following features:
the mean of molecular weight (Mw) of the PEOX is such as 40,000 Da<Mw<54,000 Da;
the monomer/initiator ratio is about 500.
   By about one should understand ±5%;
the monomer/initiator ratio is 480;
the monomer is at a Purity Superior to 99.95%;
the initiator is mixed with the acetonitrile before addition to the monomer;
the polymerisation is performed during more than 20 hours at a temperature superior to 85° C.;
the temperature of polymerisation is superior or equal to 105° C.;
after the first filtration, the residue is washed freely with a solvent such as MeOH, and after addition of diethyl ether, the poly (2-ethyl-2-oxazoline) is naturally separated as oil from solution, the overall solvent is decanted and said washing and separation is repeated at least four times before drying in vacuo;
the hydrolysing step comprises removing from the reaction mixture the discharged propionic acid obtained by azeotropic distillation regularly and during at least one day, while monitoring the process of reaction by ¹H-NMR spectroscopy;
the residue obtained at the end of the process of reaction is diluted in water and evaporated at least three times to remove traces of propionic acid, then the residue is dissolved again in water and filtered before lyophilisation;
the filtration is provided through a sterile membrane with a dimension of mesh between 0.20 μm and 0.25 μm, particularly a sterile cellular acetate membrane.

However the filtration as such is not sterile, which is therefore not involving additional cost, and this contrarily to the general opinion of the man skilled in the art, for whom sterility of the filtration would has been necessary.

By sterile filtration, one should understand elimination of all living bacterias and the living elements, at least below a value determined according to current USP.

The invention also proposes a linear PEI obtained with the above described method.

Advantageously it proposes a linear PEI characterized in that the intermediate PEOX has a molecular weight Mw such as 40,000<Mw<54,000 Da.

In an other advantageous embodiment the molecular weight Mw of PEOX is around 25,000 Da. By around one should understand ±1800 Da.

The invention will be better understood from reading the following description of the particular embodiments given by way of non limitating examples, and which refers to the accompanying drawings in which:

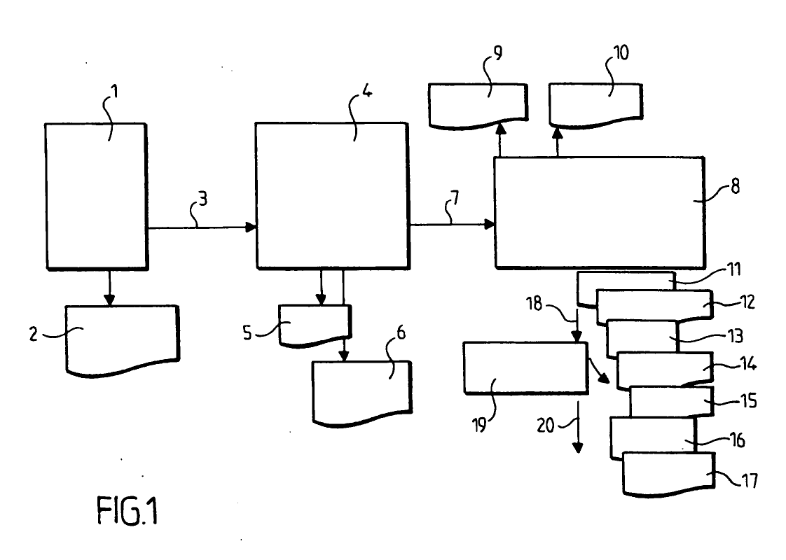

FIG. 1 shows a schematic diagram of the method of manufacturing linear PEI according to a first embodiment (GMP) of the invention.

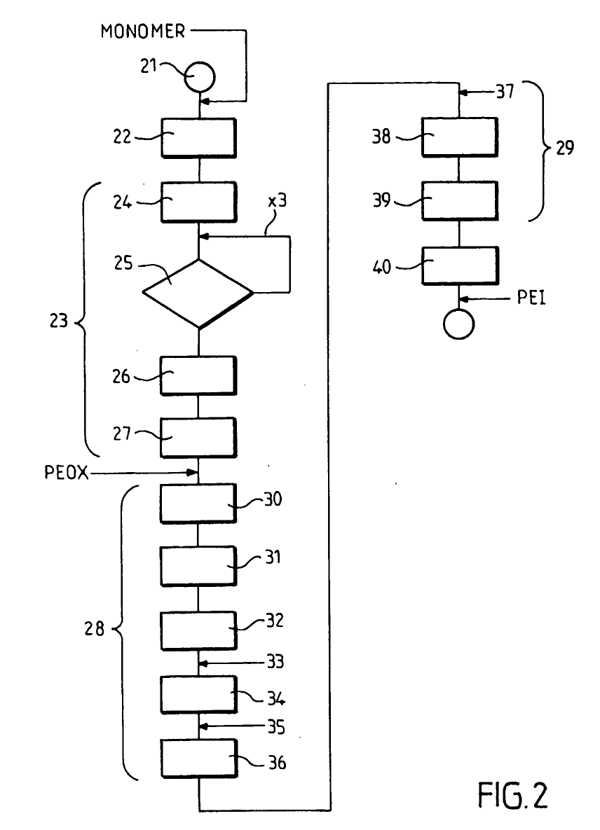

FIG. 2 shows a diagram featuring the steps of the method according to a second embodiment of the invention.

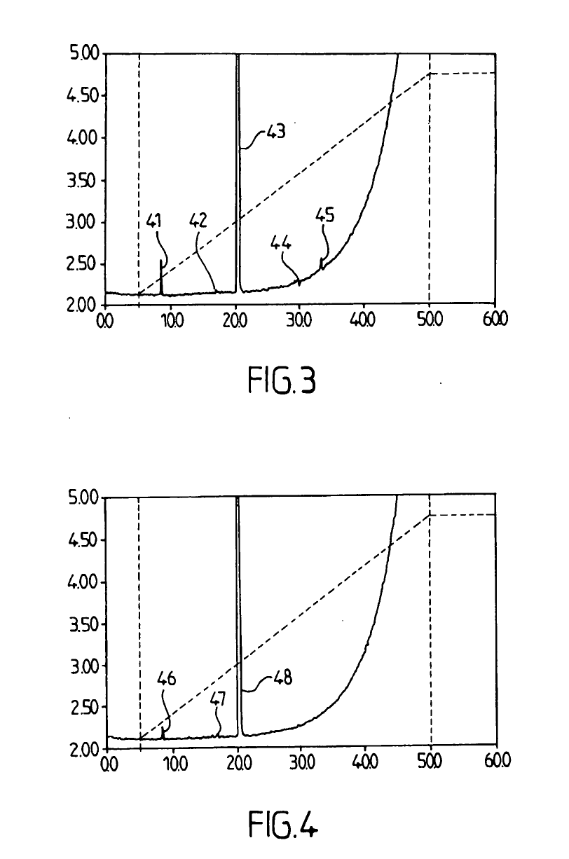

FIGS. 3 to 10 show different curbs of results obtained with a method according to an embodiment of the invention.

In a first embodiment of the method according to the invention (with the GMP quality) Poly(2-ethyl-2-oxazoline) is obtained by the cationic ring-opening polymerization of 2-ethyl-2-oxazoline (monomer) following polymerization initiation by methyl p-toluene sulfonate as a strong electrophile.

An oxazoline ring is formed (see hereafter the propagation step of the ring-opening polymerization) and then attacked by next monomer.

A living polymer is then obtained and the polymerization is terminated by the addition of water and sodium carbonate.

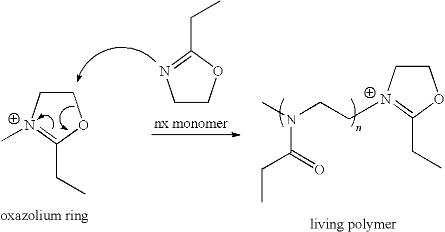

The degree of polymerization is controlled by the monomer/initiator ratio and by the yield of synthesis.

From the monomer/initiator ratio, a theoretical number-average molecular weight (Mn) can be calculated. A highly controlled polymerization, provides polymers having determined Mn near the theoretical Mn and with a low polydispersity index.

Classical yields of polymerization were in the range of 55 to 95% when the molecular weights of PEOX were expected from 1,000 to 10,000 Da (Hoogenboom et al., 2003). Yields were decreasing towards higher molecular weights. Molecular weight determination can be achieved by using ¹H-NMR spectrometry or MALDI-TOF mass spectrometry for low Mn<10,000 Da.

For higher molecular weight of PEOX>10,000 Da, gel permeation chromatography (GPC) is currently used and represents the only effective method.

The procedure of the invention relates to the process description to produce high molecular weight linear polyethylenimine, above 10,000 Da, using a highly controlled polymerization. Polymerization starting with monomer/initiator ratio of about 500 was obtained with yield superior to 90%, allowing the manufacturing of high molecular weight linear PEI with a narrow molecular weight distribution as indicated by GPC measurements and by low determined polydispersity index.

Highly controlled polymerization is exclusively obtained when the quality of the starting material (monomer, initiator) and solvent (acetonitrile) is perfectly defined and controlled.

Reagents were from the US firm Aldrich and obtained with the following specifications:
2-ethyl-2-oxazoline, Reference 13, 745-6, purity specifications >99%, determined purity by GC analysis of 99.5-99.7%, no specification about the water content;
Methyl p-toluene sulfonate, Reference 158992, purity specification >98%, determined purity by GC analysis of 99.9%.

Acetonitrile was from the italian firm Carlo Erba, Reference 0063716, HPLC grade, purity specification 99.9% and water content <0.03%.

One of the most critical parameters influencing the polymerization yield was found to be the presence of water during the initiation and the propagation step.

For this reason, vessel used is carefully dried and stored under argon before starting the synthesis.

It has also been compared the requirement of the distillation of both starting monomer and acetonitrile as we suspected that the presence of traces of water can decrease the polymerization yield (see Table 1).

The monomer and acetonitrile were dried on calcium hydride and then purified by distillation under argon prior to use.

Acetonitrile was purified by distillation prior to use.

The results showed clearly that distillation of both 2-ethyl-2-oxazoline and acetonitrile is required to obtain production yield of PEOX 90%.

In addition, a high level of reproducibility is shown. Under these conditions and using a monomer to initiator ratio of 500, PEOX polymers have molecular in the same range, 51.862+/−1.644, and an average Mw/Mn of 1.15+/−0.03.

The use of non distilled reagent or solvent generates inconsistent molecular weights.

TABLE 1
Polymerization of 2-ethyl-2-oxazoline
(monomer/initiator ratio of 500)

| | 2-ethyl-2- | aceto- | | | |
|---|---|---|---|---|---|
| Conditions | oxazoline | nitrile | Yield (%) | Mw | Mw/Mn |
| distillation | no | no | Assay 1: 66 | <40.000 | nd |
| | | | Assay 2: 85.2 | <40.000 | |
| distillation | yes | no | Assay 1: 87.2 | 43,250 | 1.17 |
| | | | Assay 2: 81.9 | 35,950 | 1.27 |
| | | | Assay 3: 93.5 | 59,400 | 1.17 |
| | | | Assay 4: 90 | 34,000 | 1.29 |
| distillation | no | yes | Assay 1: 82.8 | 37,450 | 1.47 |
| | | | Assay 2: 76.2 | 25,950 | 1.35 |
| | | | Assay 3: 55.2 | 14,100 | 1.37 |
| | | | Assay 4: 84 | 27,150 | 1.40 |
| distillation | yes | yes | Assay 1: 90 | 53,750 | 1.11 |
| | | | Assay 2: 96 | 53,150 | 1.14 |
| | | | Assay 3: 98 | 50,800 | 1.17 |
| | | | Assay 4: 96 | 49,750 | 1.19 |

Mw and Mw/Mn (polydispersity index) were obtained by gel permeation chromatography.

A Certificate of analysis of a linear PEI (GMP) is for instance provided hereafter in table 2.

Product Linear Polyethylenimine

Formula (net)(C₂H₅N)ₙ×(HCl)ₘ

TABLE 2

| Test | Method | Specifications | Result |
|---|---|---|---|
| Identification | ¹H-NMR [CDCl₃] | Identity: peaks at | |
| of the | | 1.0-1.3 ppm (3H, | |
| intermediate | | CH₂—CH₃), 2.0-2.5 ppm | |
| Poly(2-ethyl-2- | | (2H, CH₂—CH₃), | |
| oxazoline) | | 3.4-3.5 ppm (4H, | |
| | | CH₂—CH₂—N) | |
| | | Left Monomer NMT | |
| | | 1.0% | |
| | | Residuual solvent | |
| | | NMT 5% | |
| Molecular | GPC method | M_{w} = 40,000-53,000 | |
| weight of the | | Da | |
| Intermediate | | Polydispersity M_{w}/Mₙ | |
| Poly(2-ethyl-2- | | <1.5 | |
| oxazoline) | | | |
| Appearance | Visual test | Amorphous white to | |
| | | off-white solid | |
| Transfection | Transfection | >10⁷ RLU/well | |
| Assay | of adherent | | |
| | HeLa cells | | |
| | with pCMVLuc | | |
| | plasmid | | |
| Identification | IR | Conforms to | |
| of linear PEI | | reference standard | |
| | ¹H-NMR [D₂0] | Identity: peak at | |
| | | 3.3-3.6 ppm (4H) | |
| Residue of | Current USP | NMT 1.0% | |
| ignition | <281> | | |
| Heavy Metals | Current USP | NMT 0.002% | |
| | <231> (Pd) | | |
| Assay (qNMR) | ¹H-NMR method | 98.0 to 102.0% of | |
| | | (C₂H₅N)ₙ × (HCl)ₘ | |
| Impurity | GC method/¹H- | Individual unknown | |
| profile | NMR method | Impurity: NMT 0.15% | |
| | | Individual known | |
| | | Impurity: NMT 0.50% | |
| | | Total Impurities: | |
| | | NMT 1.0% | |
| ROS | GC method | Acetonitrile NMT | |
| (Residual | | 410 ppm | |
| Organic | | Methanol NMT 3,000 ppm | |
| Solvent) | | Diethylether NMT | |
| | | 5,000 ppm | |
| Microbial | Current USP | Total aerobic count | |
| limits | <61> | NMT 100 cfu/g or ml | |
| | | Yeasts and molds: | |
| | | NMT 50 cfu/g or ml | |
| | | Absence of E. coli, | |
| | | Salmonella, | |
| | | Staphylococcus | |
| | | aureus, Pseudomonas | |
| | | aeruginosa | |
| Beacterial | Current USP | NMT 0.6 EU/mg | |
| Endotoxins | <85> | | |

Cfu: colony forming units;
RLU: Relative light Unit;
EU: endotoxin units;
NMT: not more than

### Transfection Assay

One day before the transfection, 5×10⁴ HeLa cells (ATCC CCL-2) per well of a 24-well tissue culture plate in 1 ml of complete MEM medium (Eagle MEM medium with Earle's salt supplemented with 10% foetal bovine serum, sodium bicarbonate, 2 mM Glutamax™, 200 U/ml penicillin and 200 μg/ml streptomycin) are plated. The day of the transfection, in vivo-linear PEI pCMV-Luc complexes are prepared. For one well, 1 μg of DNA (pCMVLuc plasmid, 1 mg/ml, encoding the luciferase gene) is added into 50 μl of 150 mM NaCl in a microtube (1.5 ml), and then mixed with a Vortex. In vivo-linear PEI samples or positive control are added into 50 μl of 150 mM NaCl (see table for the conditions), and the solution is mixed with a Vortex. The solution of in vivo-linear PEI sample (pre-diluted with water at 7.5 mM), or linear PEI positive control (7.5 mM), or 50 μl of 150 mM NaCl solution (condition DNA alone) is added to the DNA solution at once, and then mixed with a vortex for 10 seconds. The solution (100 μl) is incubated for 30 minutes at room temperature before its addition into the well. After homogenization by gently swirling, the plate is incubated at 37° C. in a humidified air atmosphere containing 5% CO₂ for 24 hours.

| | Volume of linear PEI to add |
|---|---|
| | into 50 μl of 150 mM NaCl |
| Transfection Conditions | solution |
| Linear PEI positive | 2 μl |
| control | |
| in vivo-linear PEI | 1.2 μl |
| sample | |
| in vivo-linear PEI | 2 μl |
| sample | |
| in vivo-linear PEI | 3.2 μl |
| sample | |
| DNA alone | 0 μl |
| Cells alone | 0 μl |

One day after transfection, the luciferase assay is performed. The cell culture is removed and each well is washed with 1 ml of PBS. After removing the PBS, 100 μl of lysis buffer (Luciferase Cell Culture Lysis buffer (5×), Promega) is added, and the plate is incubated for 30 min at room temperature. The lysate is collected in a 1.5 ml microtube and centrifuge at 14,000 rpm for 5 min. Two μl of supernatant per well of the 96-well plate for luminometer (LB 960 CENTRO, Berthold Technologies) are added and the luminescence integrated over 1 second (RLU, Relative Light Unit) after automatically addition of 50 μl of luciferin substrate (Promega) is measured. Results are expressed as RLU/well. The mean of RLU/well (n=6) is then calculated ±SD.

It is now more particularly described the method in relation with FIG. 1.

From the raw material 1 (monomer and other solvents and reagents), properly qualified in 2, the step 3 of polymerisation is provided to obtain the intermediate product PEOX 4 which is properly identified in 5 and has its mass determined in step 6.

Then the acidic hydrolysis 7 is provided to obtain the linear PEI 8 properly identified in 9 and tested on a sample for transfection (transfection assay 10).

The following tests concerning appearance 11, Residue of ignition 12, presence of heavy metal 13, existence of Residual organic compounds 14, impurity profile 15, assay on endotoxin 16 and finally the bio burden (assay for the determination of the microbiological limit=quantity of microbes in cfu/g) 17 are provided, before and/or while the final step of lyophilisation 18 is performed.

The final product 19 under lyophilised form is therefore obtained before the final step of filling 20.

Briefly, the final step of filling starts by the preparation of In vivo-linear PEI bulk solution. The bulk powder is weight and solve with water to obtain a final concentration of 150 mM nitrogen. The solution is mixed approximately 1 h with a mixing speed of 200 rpm using a magnetic stirrer, and then left for 24 h at 2-8° C. The solution is filtered in room under class A conditions. For filtration a single-use sterile silicon tube and 2×Sartobran P filters (0.45 μm/0.22 μm) inline into a sterile dedicated glass vessel are used. After the integrity of the first filter was tested, the PEI solution is slowly filtered through the filters into the sterile glass vessel. At this step, samples are taken for bioburden testing. After filtration, the filling into DIN 2R vials and insertion of the rubber stopper is performed under laminar air flow. The vials are then capped with a 13 mm aluminum seal. After completion of capping process the vials will be stored at −20° C. Samples are taken and inspect for major defects.

Others (randomized) samples are taken for endotoxin and sterility assays. The vials are stored at minus 20° C. until shipment.

In a second embodiment, the manufacture and control of in vivo-linear PEI are performed in four major steps (see FIG. 2):
1) Polymerization of oxazoline to poly(2-ethyl-2-oxazoline) (PEOX);
2) purification of PEOX;
3) conversion of PEOX to polyethylenimine (linear PEI);
4) and purification of linear PEI.

More precisely, the manufacture and control steps are described hereafter in reference to FIG. 2.

From a very pure monomer.

Step 1: The method is initiated in 21. Step 1 of Polymerisation (22) is first provided

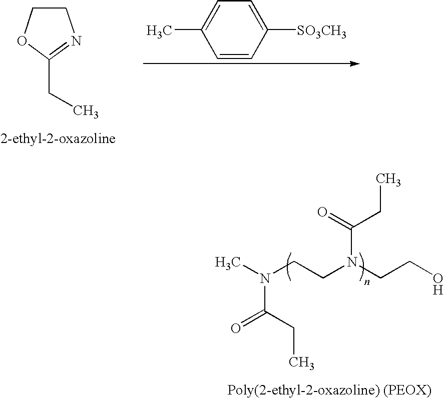

Step 2 concerns purification (23) of Poly(2-ethyl-2-oxazoline) in acetonitrile.

During said purification the following steps are performed:
precipitation (24) of polymeric materials with ether to remove the monomer;
washing (25) in three cycles of washes with methanol and ether;
evaporation (26) to remove solvents;
control (27) via In-Process Quality Controls: i.e. ¹H-NMR to identify polymer, ¹H-NMR to confirm lack of monomer, ¹H-NMR to confirm absence of solvents <1.0%.

A purified Precipitate of Poly(oxazoline) (PEOX) is then obtained.

Steps 3-4. Conversion (28) of PEOX to linear PEI and purification (29) of the Polymer.

More precisely for obtaining the purified Precipitate of Poly(oxazoline) (PEOX), the following steps are provided.
addition in 30 to 37% HCl and water;
azeotropic distillation in 31 of CH₃—CH₂—COOH with water;
addition in 32 of Hydrochloric Acid, to obtain CH₃—CH₂-COOH.

At this stage, a purified linear polyethylenimine with HCl in aqueous solution is obtained in 33.

The following steps are then provided.
Evaporation in 34 of water with removal of the excess of HCl, which allows to obtain a linear PEI, HCl solubilized in sterile water (35) and then:
Lyophilization in 36 for providing linear PEI, HCl powder.

The PEI is then rehumidified to obtain aqueous in vivo linear PEI (150 mM nitrogene) in 37, before Filtration in 38.

Then a final Bulk in vivo linear PEI Quality Testing (39 and 40) is provided i.e., before delivery of the PEI to be use for transfect:
¹H-NMR-identity and purity of in vivo linear PEI;
¹H-NMR-residual sidechains or propionic acid;
Gel Permeation-polydispersity of in vivo linear PEI;
Transfection of HeLa cells-biological activity;
Endotoxin level.

It will now be commentated in further details the above described manufacture of in vivo-linear PEI.

In the first step 22, poly(2-ethyl-2-oxazoline) (PEOX) is obtained by cationic polymerization from two starting materials, 2-ethyl-2-oxazoline and methyl-paratoluene sulfonate, in acetonitrile.

The second step 23 begins with multiple washes 25, in an equivalent (in its capacity to wash the polymer) of the methanol i.e. in this example chloroform and with ether, to precipitate the polymer, PEOX, and to remove monomers, solvents and unreacted reagents.

In-process quality testing 27 is completed on this intermediate compound.

These tests (in-process testing, see Table 3) are Nuclear Magnetic Resonance (NMR), to identify the PEOX polymer, NMR to confirm absence of monomers, and NMR to confirm absence of solvents to levels <1.0% (procedure CQ-1001).

The Gel Permeation Assay (CQ-1002) ensures polydispersity of PEOX and determines mean molecular weight.

The third step 28 is conversion of PEOX to linear PEI by cleavage of the propionate side-chain using an acidic hydrolysis with 37% hydrochloric acid in water 30.

The linear PEI purification is achieved by removing the propionic acid by azeotropic distillation 31 in water. After evaporation 34 of water and excess of hydrochloric acid, linear PEI is resuspended in sterile water (step 37) at 150 mM amine, filtered in 38 through 0.22 μm cellulose membrane into a bulk container.

The identity and purity of in vivo-linear PEI is confirmed by tests 39, 40, mainly NMR tests (see CQ-1003 of Table 3).

These tests also ensure complete removal of side chains and detect any residual propionic acid.

Then biological activity of in vivo-linear PEI is measured using a transfection assay (CQ-1004).

Finally, the level of endotoxin is measured using an Endotoxin Assay (CQ-1005).

According to the embodiments of the invention more particularly described here batch production procedures are followed throughout production of in vivo-linear PEI.

Among others, equipments, components, conditions and procedures are recorded with the operator's initials and date, while in-process and final bulk product tests are performed according to written procedures and by qualified technical staff (see here again Table 3). All tests have specifications against which results are recorded.

TABLE 3
In-Process and Final bulk Assays

| Procedure | | | Method and | Specification |
|---|---|---|---|---|
| Number | Title | Purpose (s) | Sample | to Pass |
| CQ- | Analysis for | In process: | ¹H-NMR | <5% solvant |
| 1001 | polyoxazoline | Identify the | analysis | <1% oxazoline |
| | | PEOX polymer | | monomer |
| | | | | Presence of |
| | | | | polymers |
| CQ- | Mass | In process: | Light | Polydispersity |
| 1002 | Determination by | Determine the | scattering | (Mw/Mn) < 1.5 |
| | Gel Permeation | mean molecular | and | Mean molar mass |
| | Chromatography | weight and | refractometry | (g/mol) |
| | | polydispersity | of PEOX HCl | Mn > 30,000 |
| | | of PEOX | in aqueous | |
| | | | solution | |
| | | | (Step 3) | |
| CQ- | Analysis for | Final Bulk: | ¹H-NMR | <5% |
| 1003 | polyethylenimine | Identity the | analysis on | propionic acid; |
| | (linear PEI) | linear PEI | PEI (Step 3), | Identity of |
| | | polymer and | confirm the | linear PEI as |
| | | control the | low amount of | single peak |
| | | purity | residual side | |
| | | | chains or | |
| | | | propionic | |
| | | | acid | |
| CQ- | Transfection of | Final Bulk: | Transfection | >10⁷ RLU**/well |
| 1004 | HeLa Cells Using | Demonstrate the | of adherent | |
| | linear PEI | transfection | HeLa cells | |
| | | efficiency with | with PCMVLuc | |
| | | linear PEI | plasmid and | |
| | | | linear PEI, | |
| | | | HCl (Step 4) | |
| CQ- | Endotoxin Assay | Final Bulk: | Limulus | <0.1 IU/ml Std |
| 1005 | | Measure level | amoebocyte | |
| | | of endotoxin | lysate test | |
| | | | (Step 4) | |

**RLU = Relative Light Units

A Certificate of Analysis, with specifications and results of tests, is then prepared for each batch of product such as indicated previously with the first embodiment of the invention, bearing in mind that prior to authorizing shipment of each batch of in vivo-linear PEI to the customer, a Quality Assurance Person is responsible for reviewing and approving the Batch Production Record and Certificate of Analysis.

Reaction Scheme:

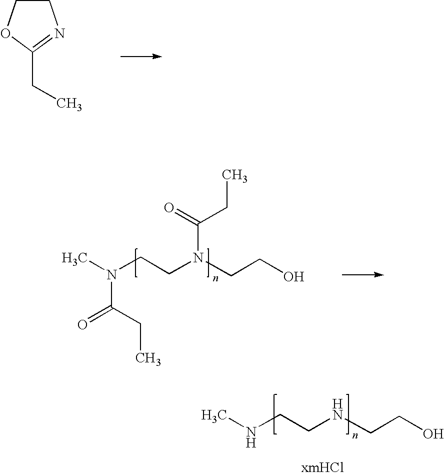

In the different examples provided, the following starting material and reagents for performing such operations are used.

2-Ethyl-2-oxazoline, ≧99%:

The monomer should be very pure, i.e. with a purity ≧99%. Here again, it could be obtained from the US firm Aldrich, ameliorated by distillation for instance to a purity, of 99.98% (see FIGS. 3 and 4).

Methyl p-toluene sulfonate is of high purity, i.e. 98%.

The initiator is for instance, and preferably Methyl p-toluene sulfonate, here again with a high purity i.e. n5%, for instance 98%.

The acid is advantageously hydrochloric acid, here again and for instance an acid purchased from the Italian firm Fluka with an acidity of 37%.

Others:

Acetonitrile was HPLC grade, the solvents methanol and ether were Ph. Eur. grade. The process aids calcium hydride and sodium carbonate were bought from Fluka.

More precisely, and in the present examples the first step of syntheses of Poly(2-ethyl-2-oxazoline) (PEOX) is as follows

Reaction:

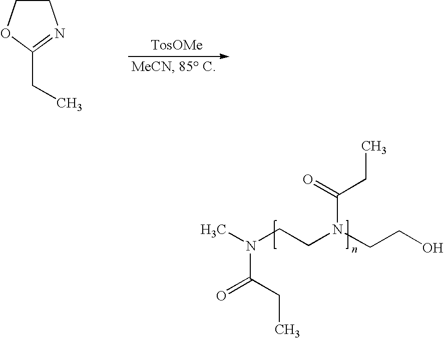

Synthesis:

Poly(2-ethyl-2-oxazoline) is synthesized starting from 2-ethyl-2-oxazoline using methyl p-toluene sulfonate as initiator for the polymerization. The reaction is carried out in a flame dried reaction flask under argon. Acetonitrile is used as solvent, the reaction temperature is 85° C.

After 24 h at 85° C., the reaction mixture is cooled to room temperature and quenched with water and sodium carbonate is added. The resulting suspension is heated for additional 24 h at 85° C. Cooling to room temperature is followed by filtration (Duran D2 glass frit) to remove the solids, washing of the filter cake with methanol and evaporation of the solvents.

The residue is dissolved in methanol and filtered again (glass fiber, Whatman B). The solvent is evaporated with an oil pump. Again, the residue is dissolved in methanol and then precipitated by the addition of diethyl ether. Subsequently the solvents are removed (oil pump vacuum). A second precipitation is made, the PEOX is then dried to constant weight.

The ¹H-NMR-spectrum has to show less than 5% of solvents and less than 1% oxazoline monomer.

It will now be described examples of realization of PEOX and PEI, one (batches N^{o} 1 and 3) without involving all the steps of the invention (i.e. it does not involve distillation in acetonitrile), with unsatisfying results and one (batches 2 and 4) involving all the steps of the invention with satisfying results.

TABLE 4
Overview of the Performed Preparations of PEOX

| | Quantity of | | Quantity of | | |
|---|---|---|---|---|---|
| Batch No. | Monomer | | Initiator | | Yield (ca. 80%) |
| 1 | 50.03 | g | 188.03 | mg | 40.95 g (81.9%) |
| | (504.7 | mmol) | (1.01 | mmol) | |
| 2 | 50.10 | g | 188.20 | mg | 43.71 g (87.2%) |
| | (505.4 | mmol) | (1.01 | mmol) | |

Achievements and analytical results:

Batch N^{o} 1:

Synthesis and work-up followed the above-mentioned protocol.

Yield: 40.95 g (81.9%) (i.e. too law)

¹H-NMR-Spectrum: The known impurity (protonated form, 1.78 ppm) is detected as well as the signals of diethyl ether. Besides these signals, a small amount of the unknown impurity with signals at 3.72 ppm is detected (FIG. 5).

TABLE 5
GPC

| Mn [g/mol] | Mw [g/mol] | Mw/Mn |
|---|---|---|
| 28,400 | 35,800 | 1.26 |
| 28,300 | 36,100 | 1.28 |

The expected molar mass for the in vivo-linear PEI consisting of 500 monomers is 49,581 g/mol.

The mean Mw is determine by GPC using the following equipments: Pump Shimadzu LC-10AD (0.5 ml/min), automatic injector WISP (Waters), 1 guard column (Shodex OH-pak K3-G, 6.0×50 mm) followed by 3 columns Shodex OH-pak, 8.0×300 mm, (1 column 803HQ, 1 column 804HQ, 1 column 806HQ) serially connected, Refractive Index Detector, differential detector Waters R410, and Multi-angle Light Scattering Detector DAWN F, Wyatt Techn. The solvent used to run the sample is bidistillated water with 0.1M NaNO₃ and NaN₃. Dried PEOX is dissolved at 4-6 g/l with the GPC solvent for 4 h under agitation and at room temperature. Before injection, the sample is subjected to filtration through a 0.22 μm Dynagard filter. 100 μl of PEOX at 4-6 g/l are automatically injected in the guard column and the GPC is realized with a flow rate of 0.5 ml/min. Monitoring the GPC is performed by following both the 90° light scattering signal and the RI signal (dn/dc). By combining the scattering signal and RI data, the absolute molar mass of polymer is calculated by the software (Software ASTRA is used).

Batch N^{o} 2:

Synthesis and work-up followed the above-mentioned protocol.

Yield: 43.71 g (87.2%) (i.e. OK)

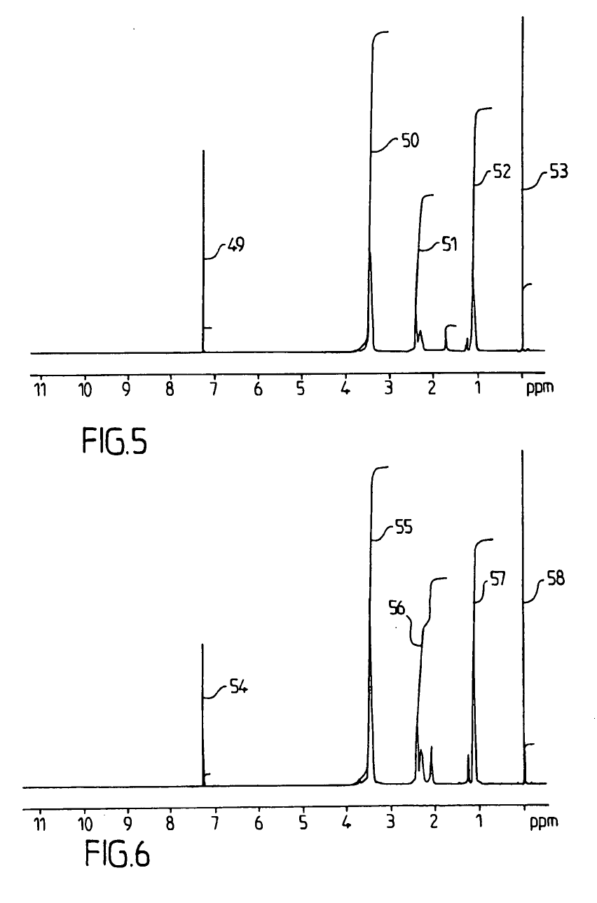

¹H-NMR-Spectrum: This spectrum shows besides the PEOX, the solvent diethyl ether and acetonitrile. Additionally the unknown impurity (at 3.72 ppm) is found (FIG. 6).

TABLE 6
GPC

| Mn [g/mol] | Mw [g/mol] | Mw/Mn |
|---|---|---|
| 37,200 | 43,200 | 1.16 |
| 36,600 | 43,300 | 1.18 |

The expected molar mass for the in vivo-linear PEI consisting of 500 monomers is 49581 g/mol.

The second step consists of performing the syntheses of Polyethylenimine (in vivo-linear PEI):

Reaction:

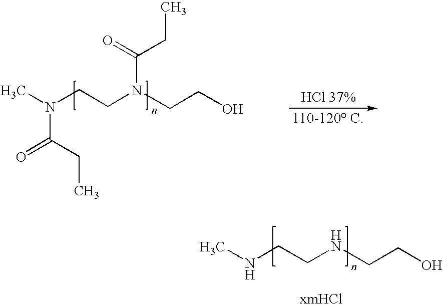

Synthesis:

For the synthesis of in vivo-linear PEI, the side chains of the intermediate above PEOX are removed by hydrolysis of the amide bond in water with hydrochloric acid. The mixture is stirred at 120° C.

After 1 day, the reaction is completed. The progress of the reaction is monitored by ¹H-NMR spectroscopy.

Not more than 5% of the side chains have to be uncleaved.

The hydrochloric acid is removed by evaporation. The residue is dissolved in water/hydrochloric acid and evaporated twice to remove traces of propionic acid.

Then, the residue is dissolved in water and filtered through a glass fiber filter (Whatman B) and then a sterile 0.22 μm cellulose acetate membrane. The colourless solution is freeze-dried.

The NMR analysis has to show the identity of the polymer, a low amount of remaining side chains and less than 5% of residual propionic acid.

Overview of the Performed Preparations of in vivo-linear PEI:

TABLE 7

| Batch No. | Quantity of PEOX | Yield (ca. 90%) |
|---|---|---|
| 3 | 39.75 g | 27.61 g (87.7%) |
| 4 | 42.51 g | 29.43 g (87.4%) |

Batch N^{o} 3 is obtained after hydrolysis of Batch N^{o} 1.

Batch N^{o} 4 is obtained after hydrolysis of Batch N^{o} 2.

Achievements and Analytical Results:

Batch N^{o} 3:

Synthesis and work-up followed the above-mentioned protocol.

Yield: 27.61 g (87.7%)

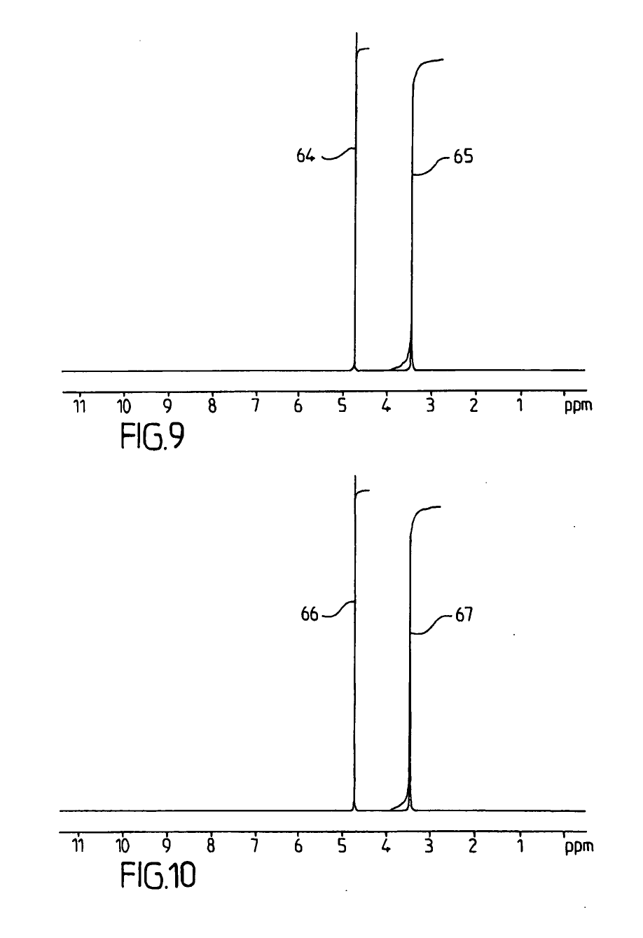

¹H-NMR-Spectrum: The spectrum shows the single peak for in vivo-linear PEI (FIG. 9).

Batch N^{o} 4:

Synthesis and work-up followed the above-mentioned protocol.

Yield: 29.43 g (87.4%)

¹H-NMR-Spectrum: The spectrum shows the single peak for in vivo-linear PEI (FIG. 10).

In Conclusion

Two Batches of linear PEI were synthesized. The purity by ¹H-NMR-spectroscopy as well as the yield of the products of the second batch was reproducible and satisfying, to be compared with the first one, not satisfying due to lack of use of some of the steps of the invention.

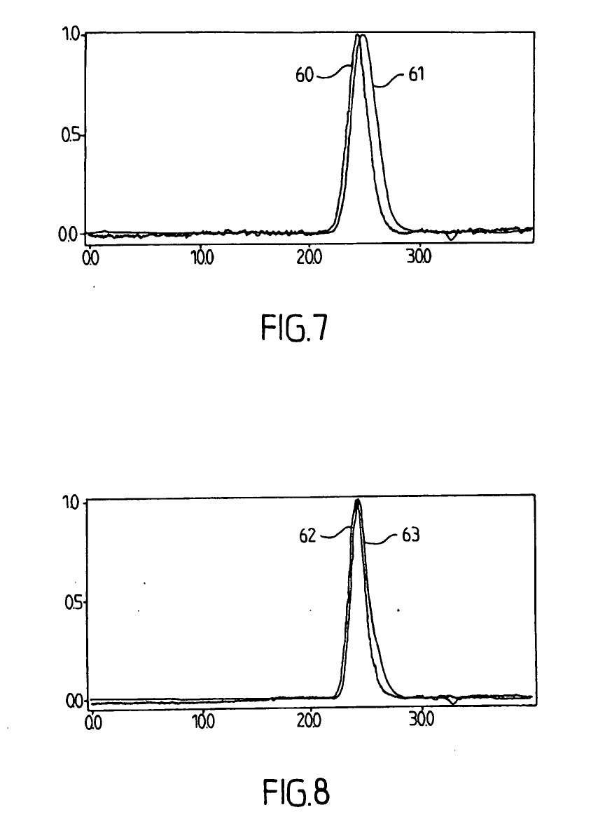

The mean molar mass of the PEOX was determined by GPC. This specification has shown to be very sensitive. In Batch N^{o} 1 the chain length did not accomplish the desired value (Table 5, FIG. 7).

The following results are now provided in correspondence with tables 8 to 14 and corresponding FIGS. 3 to 10.
1.) GC of the purchased monomer 2-ethyl-2-oxazoline (EH-1268.4-2) (see Table 8 and FIG. 3).
2.) GC of the distilled monomer 2-ethyl-2-oxazoline (EH-1268.4-2) (see Table 9 and FIG. 4).
3.) ¹H-NMR-Spectrum of Batch N^{o} 1 (see FIG. 5).
4.) ¹H-NMR-Spectrum of Batch N^{o} 2 (see FIG. 6).
5.) GPC of Batch N^{o} 1 (see FIG. 7 and Table 11)
6.) GPC of Batch N^{o} 2 (see FIG. 8 and table 12)
7.) ¹H-NMR-Spectrum of Batch N^{o} 3 (see FIG. 9).
8.) ¹H-NMR-Spectrum of Batch N^{o} 4 (see FIG. 10).

1.) GC of the Purchased Monomer 2-ethyl-2-oxazoline (EH-1268.4-2)

TABLE 8

| | Ret. | | | | | | |
|---|---|---|---|---|---|---|---|
| | Time | Peak | Height | Area | Rel. | | |
| No | Min | Name | PA | PA*min | Area % | Amount | Type |
| 1 | 8.38 | Peak 1 | 0.438 | 0.054 | 0.05 | n.a | BMB* |
| 2 | 16.78 | Peak 2 | 0.045 | 0.007 | 0.01 | n.a | BMB* |
| 3 | 20.15 | 2-Ethyl- | 905.452 | 117.657 | 99.90 | n.a | BMB* |
| | | 2-Oxa- | | | | | |
| | | zoline | | | | | |
| 4 | 29.83 | Peak 3 | 0.065 | 0.021 | 0.02 | n.a | BMB* |
| 5 | 33.42 | Peak 4 | 0.177 | 0.034 | 0.03 | n.a | BMB* |
| Total | | | 906.177 | 117.773 | 100.00 | 0.000 | |

More precisely, FIG. 3 shows clearly, with height (in PA) in Oy and time (minutes) in Ox, at a temperature of 40° C., the different peaks observed for the GC Gaz Chromatrography, i.e. peak 1 (41), peak 2 (42), the peak of 2-Ethyl-2-Oxazoline 43, peak 3 (44) and peak 4 (45) of the monomer used with the method of the invention described under the second embodiment before purification.

2.) GC of the Distilled Monomer 2-ethyl-2-oxazoline (EH-1268.4-2)

FIG. 4 and Table 9 shows the GC of the distilled monomer (just before step 22). This specific step of distillation shows that the purity of the monomer is increased when compared to the purity of the commercially available raw material (Table 8 and FIG. 3).

Only three peaks remain, i.e. peak 1 (46), peak 2 (47) and the peak of 2-Ethyl-2-Oxazoline (48).

TABLE 9

| | Ret. | | | | Rel. | | |
|---|---|---|---|---|---|---|---|
| | Time | Peak | Height | Area | Area | | |
| No | Min | Name | PA | PA*min | % | Amount | Type |
| 1 | 8.37 | Peak 1 | 0.156 | 0.020 | 0.02 | n.a | BMB* |
| 2 | 16.81 | Peak 2 | 0.042 | 0.006 | 0.01 | n.a | BMB* |
| 3 | 20.15 | 2-Ethyl- | 860.617 | 111.297 | 99.98 | n.a | BMB* |
| | | 2-Oxa- | | | | | |
| | | zoline | | | | | |
| Total | | | 860.617 | 111.297 | 100.00 | 0.000 | |

3, 4) 1H-NMR-Spectrum of batch 1 and 2

TABLE 10
Rappel: (a combination of Table 5 and 6)

| | Mn | Mw | |
|---|---|---|---|
| PEOX | [g/mol) | [g/mol) | Mw/Mn |
| Batch N^{o} 1 | 28,400 | 35,800 | 1.26 |
| | 28,300 | 36,100 | 1.28 |
| Batch N^{o} 2 | 37,200 | 43,200 | 1.16 |
| | 36,600 | 43,300 | 1.18 |

FIGS. 5 and 6 show respectively the ¹H-NMR-Spectrum of PEOX batch N^{o} 1 and ¹H-NMR-Spectrum of PEOX batch N^{o} 2.

More particularly the peaks obtained 50 to 53 and peak 55 to 58 means identify the PEOX [1.0-1.3 ppm (3H, CH₂—CH₃), 2.0-2.5 ppm (2H, CH₂—CH₃), 3.4-3.5 ppm (4H, CH₂—CH₂—N)]. Peaks 49 and 54 represent the solvent (CDCl₃).

5.) GPC (Gel Permeation Chromatography) of Batch N^{o} 1

TABLE 11 and FIG. 7

CONFIGURATION
Light scattering instrument: miniDAWN
Cell Type: K5
Laser wavelength: 690.0 nm
Calibration constant: 5.8800e−6 1/(Vcm)
RI Instrument: Optilab DSP
UV Instrument: n/a
Solvent: water
Refractive index: 1.330
Flow rate: 0.500 ml/min
PROCESSING
Mass results fitting: none (fit degree: n/a)
Radius results fitting: none (fit degree: n/a)

Peak 1

| | |
|---|---|
| Peak limits (mL) | 21.513.31.180 |
| dn/de (mL/g) | 0.162 |
| A₂ (mol mL/g²) | 0.000 |
| UV ext. (mL/g cm) | 0.000 |
| Model | 21 mm |
| Fit degree | 1 |
| Injected mass (g) | 4.6732e−4 |
| Calc. Mass (g) | 4.3112e−4 |

RESULTS

Peak 1

| | |
|---|---|
| Polydispersity | |
| Mw/Mn | 1.260 (16%) |
| Mz/Mn | 2.270 (56%) |
| Molar Mass moments (g/mol) | |
| Mn | 2.641e+4 (16%) |
| Mp | 3.516e+4 (0.9%) |
| Mw | 3.580e+4 (9%) |

The curbs 60 (raw data form the multiple angle light scattering detector, MALS) and 61 (raw data from the refractive Index detector, RI) are clearly different showing important Polydispersity (The units of the curbs are, with Volume (ml) in Ox and intensity of the signal with Relative Scale in OY), for a result which is not satisfying.

6.) GPC of Batch N^{o} 2

TABLE 12 and FIG. 8.

CONFIGURATION
Light scattering instrument: miniDAWN
Cell Type: K5
Laser wavelength: 690.0 nm
Calibration constant: 5.8800e−6 1/(Vcm)
RI Instrument: Optilab DSP
UV Instrument: n/a
Solvent: water
Refractive index: 1.390
Flow rate: 0.900 ml/min
PROCESSING
Mass results fitting: none (fit degree: n/a)
Radius results fitting: none (fit degree: n/a)

Peak 1

| | |
|---|---|
| Peak limits (mL) | 21.891.28.904 |
| dn/de (mL/g) | 0.162 |
| A₂ (mol mL/g²) | 0.000 |
| UV ext. (mL/g cm) | 0.000 |
| Model | 21 mm |
| Fit degree | 1 |
| Injected mass (g) | 6.7440e−4 |
| Calc. Mass (g) | 6.1415e−4 |

RESULTS

Peak 1

| | |
|---|---|
| Polydispersity | |
| Mw/Mn | 1.160 (16%) |
| Mz/Mn | 1.331 (22%) |
| Molar Mass moments (g/mol) | |
| Mn | 8.721e+4 (16%) |
| Mp | 4.621e+4 (0.9%) |
| Mw | 4.317e+4 (9%) |
| Mz | 4.951e+4 (18%) |

Here the curbs 62 (raw data from MALS detector) and 63 (raw data from R1 detector) are almost coinciding which is acceptable for the invention.

7, 8) Finally, it is reproduced on FIG. 9 and FIG. 10 the ¹H-NMR-Spectrum of the batches of PEI N^{o} 3 and N^{o} 4 obtained with the PEOX of Batches N^{o} 1 and 2, respectively, which shows respectively Peaks 64 (4.72 ppm, D₂O) and 65 (3.46 ppm, CH₂—CH₂₋—NH, from PEI), and 66 (4.71 ppm, D₂O), 67 (3.47 ppm, CH₂—CH₂—NH, from PEI).

Finally, it is provided hereafter Table 13.

| | Ratio initiator/monomer | | | | | | | | |
|---|---|---|---|---|---|---|---|---|---|
| | 1/250 | 1/300 | 1/350 | 1/485 | 1/500 | 1/505 | 1/520 | 1/550 | 1/600 |
| PEOX | 24,782 | 29,739 | 34,695 | 48,078 | 49,565 | 50,060 | 51,532 | 54,521 | 59,478 |
| Theoretical | | | | | | | | | |
| mass | | | | | | | | | |
| M_{w} by GPC | 21,132 | 34,180 | 31,700 | 48,230 | 51,770 | 49,180 | 51,110 | 46,700 | 60.500 |
| M_{W}/Mₙ by GPC | 1.36 | 1.46 | 1.18 | 1.19 | 1.28 | 1.27 | 1.24 | 1.29 | 1.29 |
| PEOX Yield | 85% | 85% | 92% | 96% | 94% | 90% | 91% | 87% | 93% |
| (%) | | | | | | | | | |

This table shows that the mass Mw of PEOX is depending from the initial ratio initiator/monomer.
NOTA: In this example, the final PEI has a mass >10,000 Da, and more precisely around 15,000 Da (i.e. 34,180/99×43=14,846 Da).

High performance of production of PEOX (>85%) allows the production of a polymer having a mass close to the theoretical one, with the process of the invention with, low polydispersity <1.5.

Additional advantages and modifications will readily occur to those skilled in the art. Therefore the present invention in its broader aspects is not limited to the specific details, representative device and illustrated examples shown and described herein.

In particular it covers the linear PEI obtained with the above described method.

### REFERENCES

Behr, J. 1997. The proton sponge. A trick to enter cells the virus did not explain. CHIMIA 51:34-36.
Boussif, O., Lezoualc'h, M. A., Zanta, M. D., et. al. 1995. A versatile vector ofr gene and oligonucleotide transfer into cells in culture and in vivo: polyethylenimine. Proc. Natl. Acad. Sci. USA. 92:7287-7301.
Hoogenboom, R., Fijten, M. W. M., Meier, M. A. R., & Schubert, U.S. 2003. Living cationic polymerizations utilizing an automated synthesizer: high-throughput synthesis of polyoxazolines. Macromol. Rapid Commun. 24: 92-97.
Nucleic acid containing composition, preparation and uses of same—U.S. Pat. No. 6,013,240—J-P Behr et al.

It is now described hereafter a third embodiment of the process according to the invention.

This way of manufacturing in vivo-linear PEI proceeds in a two-step-synthesis.

A first step for polymerisation from monomer (2-Ethyl-2-oxazoline) to Poly(2-ethyl-2-oxazoline) (PEOX), and a second step for obtaining the linear PEI from said PEOX.

1. A method of synthesizing and preparing linear polyethylenimine (PEI) for use as a transfection vector comprising the steps of from a determined quantity of monomer 2-ethyl-2-oxazoline at a purity superior to 99%, thoroughly drying said quantity of monomer, and polymerizing said quantity of monomer for obtaining poly(2-ethyl-2-oxazoline) (PEOX) by:
after thorough drying of a predetermined quantity of acetonitrile, using said acetonitrile as solvent in said quantity of dried monomer, while adding a predetermined quantity of thoroughly dried initiator of the reaction of polymerization, and mixing them altogether,
purifying said obtained PEOX by evaporation to remove said solvent, while performing at least three times successive washing/precipitation steps with methanol and diethyl ether and corresponding filtrations,
said operations of drying, polymerizing, and purifying being arranged to obtain (i), by performing ¹H-NMR tests, correct identification of said PEOX polymer, confirmation of absence of monomer to a level <1.0% and confirmation of absence of solvent to a level <5.0% and (ii), by performing Gel Permeation Chromatography, a mean of molecular weight (Mw)>23,000 Da and polydispersity (Mw/Mn) of said PEOX<1.5,
hydrolyzing said PEOX with hydrochloric acid for obtaining said PEI sufficiently efficiently to have, by performing ¹H-NMR tests, an amount of residual side chains or propionic acid <5% and to identify the PEI as a single peak.

2. The method according to claim 1, characterized in that the mean of molecular weight (Mw) of intermediate PEOX is 40,000 Da<Mw<54,000 Da.

3. The method according to claim 1, characterized in that the monomer/initiator ratio is about 500.

4. The method according to claim 3, characterized in that the monomer/initiator ratio is 480.

5. The method according to claim 4, characterized in that the monomer is at a purity superior to 99.95%.

6. The method according to claim 5, characterized in that the initiator is mixed with the acetonitrile before addition to the monomer.

7. The method according to claim 6, characterized in that the polymerization is performed during more than 20 hours at a temperature superior to 85° C.

8. The method according to claim 7, characterized in that the temperature of polymerization is superior to 105° C.

9. The method according to claim 1, characterized in that, after the first filtration, the residue is washed freely with MeOH, and in that after addition of diethyl ether, the poly (2-ethyl-2-oxazoline) is naturally separated as oil from solution, the overall solvent is decanted and said washing and separation is repeated at least four times before drying in vacuo.

10. The method according to claim 1, characterized in that the hydrolyzing step comprises removing from the reaction mixture the discharged propionic acid obtained by azeotropic distillation regularly and during at least one day, while monitoring the process of reaction by ¹H-NMR spectroscopy.

11. the method according to claim 10, characterized in that the residue obtained at the end of the process of reaction is diluted in water and evaporated at least three times to remove traces of propionic acid, then the residue is dissolved again in water and filtered before lyophilisation.

12. The method according to claim 11, characterized in that the filtration is provided through a sterile cellulose acetate membrane with a dimension of mesh between 0.20 μm and 0.25 μm.

13. The linear PEI such as obtained by the method according to claim 1, by purification of an intermediate product (PEOX) having less than 1.0% of monomer, less than 5.0% of presence of solvent, a molecular weight Mw>23,000 Da, a polydispersity Mw/Mn less than 1.5.

14. The linear PEI according to claim 13, characterized in that the intermediate product PEOX has a molecular weight Mw of PEOX such as 40,000<Mw<53,000 Da.

15. The linear PEI according to claim 13, characterized in that the intermediate product PEOX has a molecular weight MW around 25,000 Da.
